(19) United States
(12) Patent Application Publication
(10) Pub. No.: US 2009/0196413 A1
(43) Pub. Date: Aug. 6, 2009

(54) ANALOG TRUNK AND METHOD FOR OPTIMIZING VOICE QUALITY IN ANALOG TRUNK

(75) Inventor: Kwang-Jin AHN, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/353,718

(22) Filed: Jan. 14, 2009

(30) Foreign Application Priority Data
Feb. 4, 2008 (KR) 10-2008-0011142

(51) Int. Cl. H04M 9/08

(52) U.S. Cl. 379/406.04

(57) ABSTRACT

A method for optimizing voice quality in an analog trunk is provided. The method includes setting a loop parameter to optimize an Echo Return Loss (ERL) property for a loop distance, generating a tone according to a value of the loop parameter and measuring ERL values from the tone, and setting a loop parameter value corresponding to a smallest ERL value of the measured ERL values, as an optimized loop parameter.

### CLAIM OF PRIORITY

This application claims the benefit under 35 U.S.C. § 119(a) of a Korean patent application filed on Feb. 4, 2008 in the Korean Intellectual Property Office and assigned Serial No. 10-2008-0011142, the entire disclosure of which is hereby incorporated by reference.

### BACKGROUND OF THE INVENTION

1. Field of the Invention

The present invention relates to an analog trunk and a method for optimizing voice quality in the analog trunk. More particularly, the present invention relates to an analog trunk in which a parameter determining voice quality is optimized according to a loop distance in a Voice over Internet Protocol (VoIP) call via the analog trunk and a method for optimizing voice quality in the analog trunk.

2. Description of the Related Art

An echo refers to a phenomenon in which a sound wave from a sound source is heard again due to a reflection of the sound wave from an object. The echo may be classified into an acoustic echo and a hybrid echo.

The acoustic echo refers to a signal being returned to a transmitting stage of a near-end talker by the reflection of the signal from a communication terminal.

On the other hand, the hybrid echo is generated in a hybrid circuit that is a 4-wired/2-wired (4 W/2 W) connection circuit of a Public Switched Telephone Network (PSTN). A Private Branch Exchange (PBX) is connected to a public exchange or another private branch exchange via an analog trunk. In this case, the analog trunk includes a 4-wired/2-wired connection circuit to separate lines for transmission/reception signals. Accordingly, when an Internet Protocol (IP) network is connected to the PSTN, hybrid echo is generated.

A signal from the echo can severely degrade call quality, depending on the echo's delay time and size. Accordingly, an echo canceller is used to cancel the echo signal. The echo canceller presumes a path for the echo signal using an adaptation filter and cancels effects of noise and the echo signal from an anticipated signal.

FIG. 1 illustrates an amount of current and an attenuated amount of a signal according to a length of a central office loop according to the conventional art.

When a user talks with a correspondent via a central office, communication sensitivity may be degraded depending on a change in the loop length of the central office. Signal sensitivity is commonly reduced by 1 dB per 1 km of loop length of the central office. Accordingly, when the loop length of the central office is 7 km, the signal sensitivity is reduced by about 7 dB. During communication, the attenuation of the signal sensitivity appears as attenuation of an amount of communication sound between subscribers, with the result that the subscribers cannot listen to an exact voice of the correspondent.

Recently, the use of IP or VoIP phones has gained in popularity. When a call is established via the IP or VoIP phone and a path of the call is via the analog trunk, an echo is generated upon a 2 W/4 W conversion in the circuit of the analog trunk. In this case, an echo canceller of a Digital Signal Processor (DSP) that processes a Real Time Protocol (RTP) packet attenuates the echo.

In order for the DSP to process the echo, a minimum Echo Return Loss (ERL), as defined in the International Telecommunication Union (ITU) G.168 standard, is guaranteed in the analog trunk. The ITU G.168 standard defines the minimum ERL value as 6 dB.

The ERL property depends on a state of a loop, such as a line condition of a central office, a distance from a correspondent and the like. That is, the ERL property varies with a line length of the central office. When the ERL property is optimized for a specific loop, the ERL property is degraded in other line sections. When the ERL property is degraded, it is necessary to adjust an ERL parameter of an echo canceller in order to reduce the echo. Accordingly, when double talk occurs, which includes an echo version of a far-end talker signal and a near-end talker signal, the voice quality is degraded.

In other words, since the ERL varies with the loop state when a balance circuit is formed in a conventional analog trunk, it is difficult to optimize an operation of the echo canceller.

Therefore, a need exists for an analog trunk providing optimized voice quality and method for optimizing voice quality in the analog trunk.

### SUMMARY OF THE INVENTION

An aspect of the present invention is to address at least the above-mentioned problems and/or disadvantages and to provide at least the advantages described below. Accordingly, an aspect of the present invention is to provide an analog trunk providing optimized voice quality upon connecting a VoIP call and a method for optimizing voice quality in an analog trunk.

In accordance with an aspect of the present invention, a method for optimizing voice quality in an analog trunk is provided. The method includes setting loop parameters to optimize an Echo Return Loss (ERL) property for loop distances, generating a tone according to a value of each loop parameter and measuring ERL values from the tone, and setting a loop parameter value corresponding to a smallest ERL value of the measured ERL values, as an optimized loop parameter.

The loop parameter may include at least one of intensity of a transmitted signal, intensity of a received signal and a return loss.

Each loop distance may be initially set to 0 km and increased from 0 km in increments of 1 km.

The generating of the tone, according to each loop parameter value, may include generating a tone in a band similar to a voice band.

The generating of the tone, according to each loop parameter value, may include disabling an echo canceller.

When the generated tone, according to each loop parameter value, is returned as an echo, an ERL value may be measured from the echo.

The setting of the loop parameters may include measuring the ERL value, according to each loop parameter value, selecting the smallest ERL value of the measured ERL values, and setting a loop parameter value corresponding to the smallest ERL value as an optimized loop parameter.

In accordance with another aspect of the present invention, an analog trunk is provided. The analog trunk includes a central processing unit for setting loop parameters to optimize an Echo Return Loss (ERL) property for loop distances, a tone generator for generating a tone according to a value of the loop parameters, and a parameter setting unit for setting a loop parameter value, corresponding to a smallest ERL value of the measured ERL values from the generated tone, as an optimized loop parameter.

The loop parameter may include at least one of intensity of a transmitted signal, intensity of a received signal, and a return loss.

The central processing unit may initially set the loop distance to 0 km and increase the loop distance from 0 km in increments of 1 km.

The tone generator may generate a tone, according to each loop parameter value, in a band similar to a voice band.

The central processing unit may disable an echo canceller when the tone generator generates the tone according to each loop parameter value.

The parameter setting unit may measure an ERL value from an echo when the generated tone, according to each loop parameter value, is returned as the echo.

The parameter setting unit may measure the ERL value according to each loop parameter value, from the generated tone by the tone generator, select the smallest ERL value of the measured ERL values, and set a loop parameter value corresponding to the smallest ERL value as an optimized loop parameter.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates an amount of current and an attenuated amount of a signal according to a length of a central office loop according to the conventional art;

FIG. 2 illustrates an Echo Return Loss (ERL) property for central office distances optimized with at least one of a single parameter or hardware according to an exemplary embodiment of the present invention;

FIG. 3 illustrates an ERL property for each central office distance measured after the ERL property is optimized by a method for optimizing voice quality according to an exemplary embodiment of the present invention;

FIG. 4 is a block diagram of an analog trunk according to an exemplary embodiment of the present invention;

FIG. 5 illustrates a process of setting a parameter corresponding to an optimized ERL value according to an exemplary embodiment of the present invention; and

FIG. 6 illustrates a process of optimizing an ERL property according to a distance for each central office according to an exemplary embodiment of the present invention.

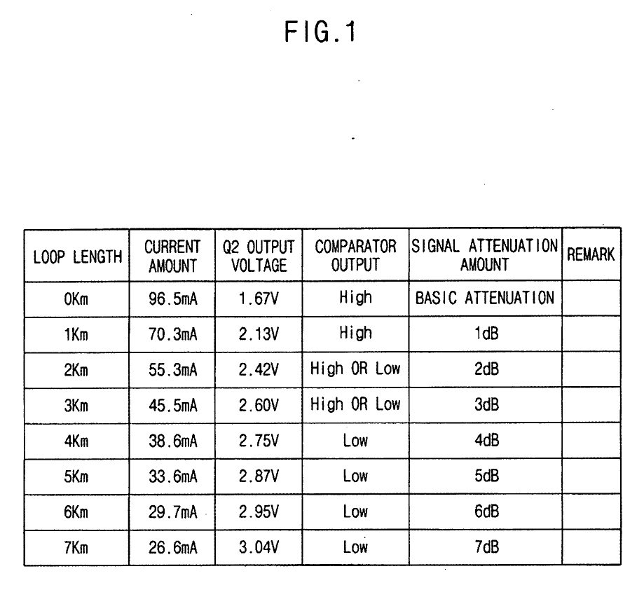

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In an analog trunk, voice quality varies with a loop length of a connected analog trunk line. Conventionally, a Design Automation (DA) chip designer obtains an optimized loop length through experiments and adjusts an Echo Return Loss (ERL) value of a central office according to the optimized loop length as a register value upon designing the DA chip.

In this case, since circuitry hardware is fixed, deviation from a loop length corresponding to an optimal property degrades voice quality. In addition, since a loop matching value is fixed irrespective of the loop length, optimal voice quality cannot be present according to the loop length of the analog trunk line.

Accordingly, in an exemplary embodiment of the present invention, a parameter is set to obtain an optimized ERL value for each loop distance and the optimal ERL value is set according to the loop distance

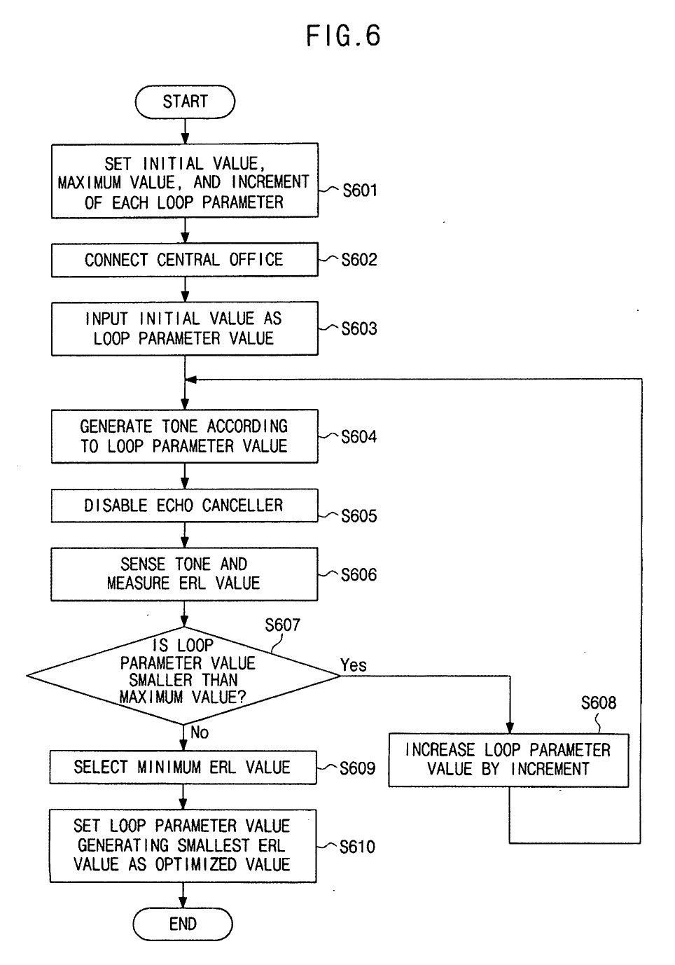

In an exemplary implementation, the present invention includes a process of setting a parameter corresponding to an optimized ERL value and a process of setting an optimal ERL value according to a loop distance. An exemplary process of setting a parameter will be described with respect to FIG. 5 and an exemplary process of setting an optimal ERL value according to the loop distance will be described with respect to FIG. 6.

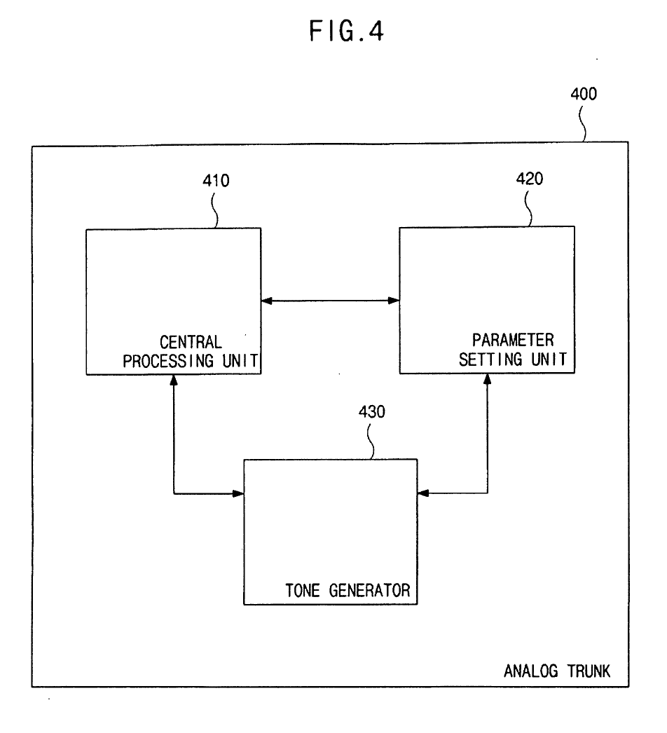

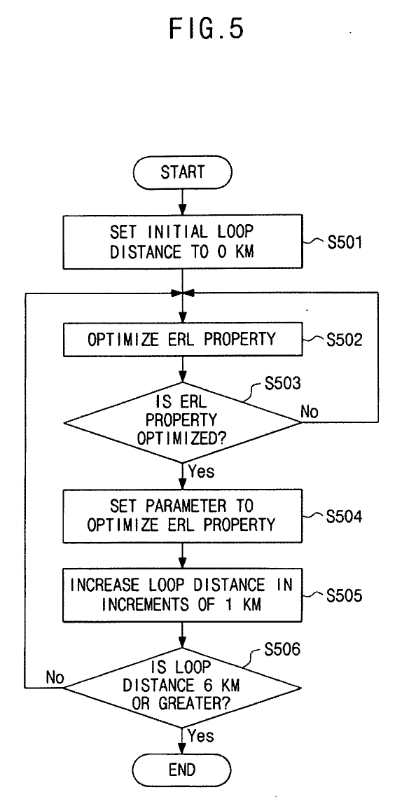

FIG. 4 is a block diagram of an analog trunk according to an exemplary embodiment of the present invention.

An analog trunk 400 according to an exemplary embodiment of the present invention includes a central processing unit 410, a parameter setting unit 420 and a tone generator 430.

The central processing unit 410 sets a parameter to optimize an ERL property for each specific loop distance. The parameter includes intensity of a transmitted signal from a transmitting (Tx) unit, intensity of a received signal in a receiving (Rx) unit, a Return Loss (RL) and the like. Specifically, the central processing unit 410 initially sets the loop distance to 0 km, and sets the parameter to optimize the ERL property for each loop distance while increasing the loop distance in increments of 1 km. The central processing unit 410 repeatedly performs the setting of the loop distance in increments of 1 km and the setting of the parameters to optimize the ERL until the loop distance reaches 6 km. In this case, the parameter to optimize the ERL property for each loop distance set by the central processing unit 410 is hereinafter defined as a “loop parameter”.

In an exemplary implementation, the loop distance is assumed to increase in increments of 1 km. However, the loop distance may increase in smaller increments. The fine increments of the loop distance help further optimize the ERL property according to the loop distance.

When the tone generator 430 generates a tone according to the loop parameter value, the central processing unit disables an echo canceller.

The parameter setting unit 420 sets an initial value, a maximum value and an increment of each loop parameter.

The parameter setting unit 420 sets the loop parameter value to the initial value and increases the loop parameter value by a predetermined value (i.e., an increment) until the loop parameter value reaches the maximum value. In this case, the parameter setting unit 420 sends information on the set loop parameter value to the tone generator 430.

Meanwhile, the parameter setting unit 420 measures the ERL value according to the loop parameter value from the tone generated by the tone generator 430. The parameter setting unit 420 selects the smallest ERL value of the measured ERL values and sets a loop parameter value corresponding to the smallest ERL value as an optimal value.

The tone generator 430 generates a tone according to the loop parameter value. In this case, the tone generator 430 generates a tone in a band similar to a voice band, i.e., a tone in the range of 400 Hz to 700 Hz.

FIG. 5 illustrates a process of setting a parameter corresponding to an optimized ERL value according to an exemplary embodiment of the present invention.

Recently, a number of DA chips have been made available to adjust an ERL value of a central office with a register value. In exemplary embodiments of the present invention, an ERL property of a commercially available DA chip is set for each loop. However, the ERL property is set in different ways. That is, a method for optimizing the ERL property may be modified depending on a simulation or hardware design of the DA chip. Therefore, a description of the method will be omitted.

Referring to FIG. 5, when a process of setting a parameter is initiated, the analog trunk 400 sets an initial loop distance to 0 km in step S501. In this case, the loop distance of 0 km indicates that a loop length between a user and an analog trunk line is equal to 0 km.

The analog trunk 400 optimizes the ERL property according to the set loop distance in step S502. As described previously, different optimizations for the ERL property may be applied to DA chips.

The analog trunk 400 determines whether the ERL property is optimized in step S503. If the ERL property is not optimized, the analog trunk 400 returns to step S502 in which the ERL property is optimized. However, if the ERL property is optimized, the analog trunk 400 sets a parameter to optimize the ERL property in step S504.

When the analog trunk 400 sets a parameter according to the initial loop distance, the analog trunk 400 increases the loop distance in increments of 1 km in step S505. Thus, the initial loop distance is set to 0 km and then the loop distance increases in increments of 1 km from the initial loop distance.

The analog trunk 400 determines whether the loop distance is 6 km or greater in step S506. In an exemplary implementation, it is assumed that the loop distance is divided into ranges of 0 km to 1 km, 1 km to 2 km, 2 km to 3 km, 3 km to 4 km, 4 km to 5 km and 5 km to 6 km, and the parameter to optimize the ERL property is set for each range. However, in another exemplary implementation, the loop distance may be divided into fewer ranges which are expected to yield a better result.

When the loop distance is less than 6 km, the analog trunk 400 returns to step S502 in which the ERL property according to the loop distance set in step S505 is optimized.

On the other hand, when the loop distance is 6 km or greater, the analog trunk 400 terminates the setting of the parameter process according to distances for each central office.

In an exemplary implementation, the ERL property according to a distance for each central office may be improved by setting the parameter to optimize the ERL property. Meanwhile, after the parameter, which may have the ERL value optimized according to the loop distance, is set. The set parameter may be used to set an optimal ERL value according to the loop distance, which will be described in detail with respect to FIG. 6.

FIG. 6 illustrates a process of optimizing an ERL property according to a distance for each central office according to an exemplary embodiment of the present invention.

The analog trunk 400 occupies a central office, generates a real tone for each parameter and sets a parameter value indicating the smallest ERL value of ERL values measured using the real tone, as an optimization parameter.

When the process of optimizing the ERL property is initiated, the analog trunk 400 sets an initial value, a maximum value and an increment of each loop parameter in step S601. In this case, the analog trunk 400 connects a central office to generate a real tone in step S602.

The analog trunk 400 inputs the initial value as the loop parameter value in step S603, and generates a tone according to the loop parameter value in step S604. In this case, the analog trunk 400 generates a tone in a band similar to a voice band in order to simulate a real voice and a corresponding echo to guarantee voice quality of a call. The tone in the band similar to the voice band is in a range of 400 Hz to 700 Hz. Accordingly, the analog trunk 400 generates a tone in the voice band.

The analog trunk 400 disables the echo canceller in order to measure the ERL value of the tone generated by the tone generator 430 and returned from a hybrid circuit in step S605. In this case, the analog trunk 400 determines a tone comprising the echo, and measures the ERL value in step S606.

The analog trunk 400 determines whether the loop parameter value is smaller than the maximum value in step S607. If the loop parameter value is smaller than the maximum value, the analog trunk 400 increases the loop parameter value by the increment in step S608. In this case, the process returns to step S604 to measure the ERL value according to the loop parameter value.

If the loop parameter value is greater than or equal to the maximum value, the analog trunk 400 selects the minimum value of the measured ERL values in step S609. In this case, the analog trunk 400 sets the loop parameter value corresponding to the smallest ERL value as an optimized loop parameter in step S610.

The process of optimizing the ERL property according to a distance for each central office is completed.

Echo in a VoIP system and voice dropout in double talk are commonly caused when the call path is via the analog trunk.

In an exemplary implementation, an optimized central office parameter is automatically set to improve both echo removal and voice quality of double talk in a VoIP exchange system or terminal using an analog trunk.

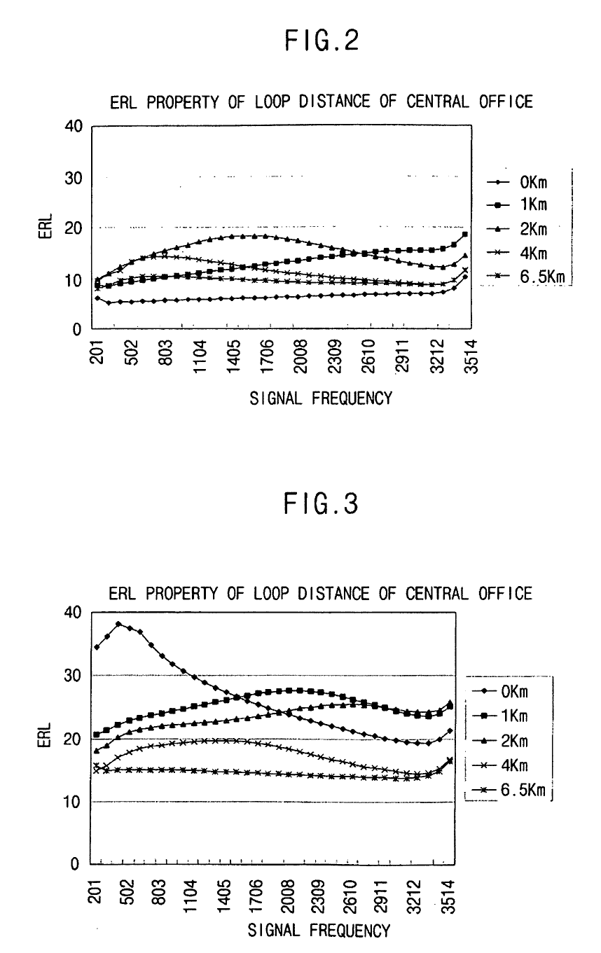

FIGS. 2 and 3 show changes in an ERL property according to a loop distance, i.e., 0, 1, 2, 4, and 6.5 km, of an analog trunk according to an exemplary embodiment of the present invention.

FIG. 2 illustrates an ERL property for each central office distance optimized with a single parameter or hardware. The ERL property is not greatly changed with a changed loop distance. Accordingly, deviation from a specific loop distance corresponding to an optimized ERL property may degrade voice quality.

FIG. 3 illustrates an ERL property for each central office distance measured after the ERL property is optimized by the method for optimizing voice quality according to an exemplary embodiment of the present invention.

Since the optimized ERL property for the specific loop distance has been set, the ERL property is changed with the changed loop distance, unlike in FIG. 2. In this case, because the optimized ERL property for each loop distance is set, the deviation from the specific loop distance does not degrade voice quality.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for optimizing voice quality in an analog trunk, the method comprising:
setting a loop parameter to optimize an Echo Return Loss (ERL) property for a loop distance;
generating a tone according to a value of each loop parameter and measuring ERL values from the tone; and
setting a loop parameter value corresponding to a smallest ERL value of the measured ERL values, as an optimized loop parameter.

2. The method of claim 1, wherein the loop parameter includes at least one of intensity of a transmitted signal, intensity of a received signal and return loss.

3. The method of claim 1, wherein each loop distance is initially set to 0 km and increased from 0 km in increments of 1 km.

4. The method of claim 3, wherein the loop distance increments until the loop distance reaches about 6 km.

5. The method of claim 1, wherein the generating of the tone according to the loop parameter value comprises generating a tone in a band similar to a voice band.

6. The method of claim 5, wherein the voice band comprises a tone in a range of about 400 Hz to about 700 Hz.

7. The method of claim 1, wherein the generating of the tone according to the loop parameter value comprises disabling an echo canceller.

8. The method of claim 7, wherein when the generated tone, according to the loop parameter value, is returned as an echo, the measuring of ERL values from the tone comprises measuring ERL values from the echo.

9. The method of claim 1, wherein the setting of the loop parameters comprises measuring the ERL value, according to the loop parameter value, selecting the smallest ERL value of the measured ERL values, and setting a loop parameter value corresponding to the smallest ERL value as an optimized loop parameter.

10. The method of claim 1, wherein the set loop parameter value comprises at least one of an initial value, a maximum value and an increment.

11. An analog trunk comprising:
a central processing unit for setting a loop parameter to optimize an Echo Return Loss (ERL) property for a loop distance;
a tone generator for generating a tone according to a value of the loop parameter; and
a parameter setting unit for setting a loop parameter value, corresponding to a smallest ERL value of measured ERL values from the generated tone, as an optimized loop parameter.

12. The analog trunk of claim 11, wherein the loop parameter includes at least one of intensity of a transmitted signal, intensity of a received signal and a return loss.

13. The analog trunk of claim 11, wherein the central processing unit sets the loop distance to 0 km and increases the loop distance from 0 km in increments of 1 km.

14. The analog trunk of claim 11, wherein the tone generator generates tone, according to the loop parameter value, in a band similar to a voice band.

15. The analog trunk of claim 14, wherein the voice band comprises a tone in a range of about 400 Hz to about 700 Hz.

16. The analog trunk of claim 11, wherein the central processing unit disables an echo canceller when the tone generator generates the tone according to the loop parameter value.

17. The analog trunk of claim 16, wherein the parameter setting unit measures an ERL value from an echo when the generated tone, according to the loop parameter value, is returned as the echo.

18. The analog trunk of claim 11, wherein the parameter setting unit measures the ERL value, according to the loop parameter value, from the generated tone by the tone generator, selects the smallest ERL value of the measured ERL values, and sets a loop parameter value corresponding to the smallest ERL value as an optimized loop parameter.

19. The analog trunk of claim 11, wherein the loop distance increments until the loop distance reaches about 6 km.

20. The analog trunk of claim 11, wherein the parameter setting unit transmits information regarding the set loop parameter value to the tone generator.
